(19) United States
(12) Patent Application Publication
(10) Pub. No.: US 2002/0087422 A1
(43) Pub. Date: Jul. 4, 2002

(54) Method, system and program product for providing an estimated date of delivery in an electronic transaction

(75) Inventors: Ravindra R. Mantena, Morrisville, NC (US); Christina L. Mattoon, Danbury, CT (US); Bijay Satpathy, Danbury, CT (US); Julie A. Wheeler-Cyran, New Fairfield, CT (US)

Correspondence Address: HESLIN ROTHENBERG FARLEY & MESITI PC, 5 COLUMBIA CIRCLE, ALBANY, NY, 12203, US

(73) Assignee: International Business Machines Corporation, Armonk, NY (US)

(21) Appl. No.: 09/752,331

(22) Filed: Dec. 29, 2000

(51) Int. Cl. G06F 17/60

(52) U.S. Cl. 705/26

(57) ABSTRACT

An estimated date of delivery in an electronic transaction is provided to a public electronic environment (e.g., a browser on a global computer network) from a private electronic environment (e.g., an ERP application on a private computer network) by electronically sending from a requestor a request for an estimated date of delivery for a made-to-order or out-of-stock item via a public electronic environment; automatically routing the request to a private electronic environment; obtaining the estimated date of delivery within the private electronic environment while the requestor waits; and automatically returning the estimated date of delivery from the private electronic environment to the public electronic environment for providing to the requestor.

### BACKGROUND OF THE INVENTION

1. Technical Field

The present invention generally relates to obtaining an estimated date of delivery in an electronic transaction. More particularly, the present invention relates to obtaining an estimated date of delivery for made-to-order and out-of-stock items in a public electronic environment from a private electronic environment.

2. Background Information

Electronic transactions involving the purchase of various goods and services have steadily increased with the popularity and use of public electronic environments, such as, for example, global computer networks (e.g., the INTERNET). Where made-to-order and out-of-stock items are desired, it has proven to be problematic for electronic merchants to identify with any degree of certainty a date of delivery for the goods while the buyer is still in the shopping session, without resorting to chaotic behind-the-scenes manual intervention. Such uncertainty is inconvenient for individuals, and potentially costly for companies doing the purchasing. Often, an electronic merchant will simply indicate for the buyer to call the merchant for more information. Worse, for example, some electronic merchants simply prevent out-of-stock items from being ordered at all, with no indication of when the buyer could order the item.

Due to inventory uncertainty, manufacturing uncertainty, supplier uncertainty, order volume variations, etc., the calculation of an estimated date of delivery for made-to-order and out-of-stock items is no trivial matter for many electronic merchants. The information needed to calculate the estimated date of delivery typically resides in a private electronic environment, such as, for example, a secure computer or computer network housing an Enterprise Resource Planning (ERP) application. ERP applications are large, expensive and complex computer programs that track massive volumes of data (e.g., base prices, inventory levels, manufacturing schedules, delivery schedules, etc.). Due to the sensitive nature of such information, the ERP applications have not been made accessible from public electronic environments for security reasons.

It has been suggested that separate delivery date engines be developed for commerce sites to provide an estimated date of delivery. However, since the key data resides with the ERP application, such engines would require that the data be kept current in more than one location. Such a situation could result in a delivery date provided to the buyer that is not nearly accurate enough. Such confusion causes various problems for corporate buyers, for example, not the least of which is scheduling deployment of new equipment, and serves only to reduce the credibility of the electronic merchant.

Thus, a need exists for a way to provide a real-time estimated date of delivery for made-to-order and out-of-stock items in an electronic transaction.

### SUMMARY OF THE INVENTION

Briefly, the present invention satisfies the need for a way to provide a real-time estimated date of delivery for made-to-order and out-of-stock items in an electronic transaction by providing a secure communication link between a public electronic environment and a private electronic environment for requesting, obtaining and returning the same.

In accordance with the above, it is an object of the present invention to provide a real-time estimated date of delivery in an electronic transaction.

The present invention provides, in a first aspect, a method of providing an estimated date of delivery for a made-to-order or out-of-stock item in an electronic transaction. The method comprises electronically sending by a requestor a request for an estimated date of delivery from a public electronic environment, automatically routing the request to a private electronic environment, obtaining the estimated date of delivery within the private electronic environment while the requestor waits, and automatically returning the estimated date of delivery from the private electronic environment to the public electronic environment for providing to the requestor.

The present invention also provides a system and program product in second and third aspects, respectively, implementing the method of the first aspect of the invention.

These, and other objects, features and advantages of this invention will become apparent from the following detailed description of the various aspects of the invention taken in conjunction with the accompanying drawings.

### BRIEF DESCRIPTION OF THE DRAWINGS

FIG. 1 is a simplified block diagram of a computing environment useful with the present invention.

FIG. 2 is a block diagram of a system for providing an estimated date of delivery in an electronic transaction.

### DETAILED DESCRIPTION OF THE INVENTION

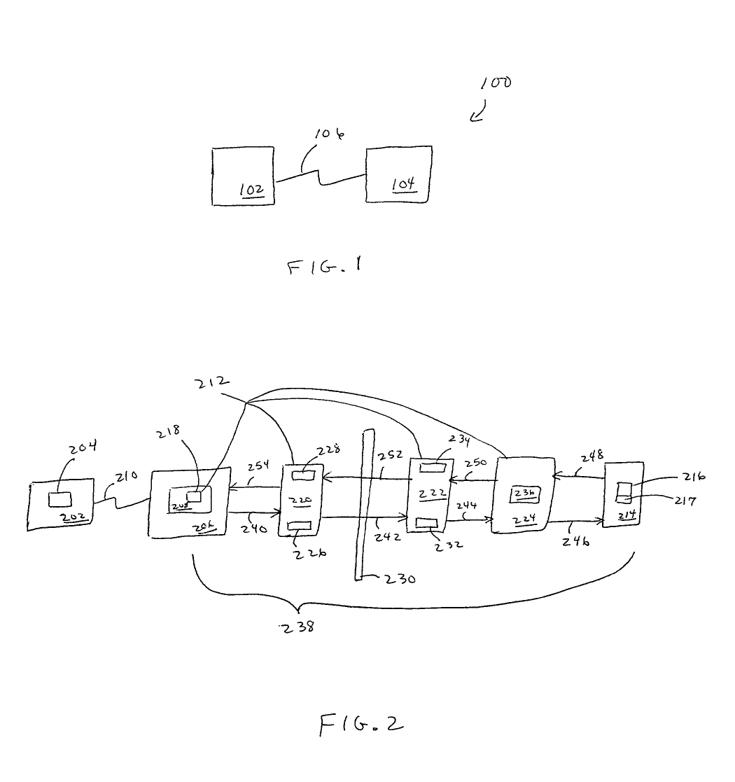

One example of a computing environment useful with the present invention is described with reference to FIG. 1. A computing environment 100 includes, for instance, at least one computing unit 102 coupled to at least one other computing unit 104. In one example, computing unit 102 is a buyer's computer, while computing unit 104 is a server for an electronic merchant. Each unit includes, for example, one or more central processing units, memory, one or more storage devices and one or more input/output devices, as is well known in the art.

Computing unit 104 is, for example, an IBM system running AIX, a Unix derivative Operating System, and computing unit 102 is, for instance, a personal computer, such as a personal computer with Microsoft WINDOWS as the operating system, and based on the Intel PC architecture.

Computing unit 102 is coupled to computing unit 104 via a standard connection 106, such as any type of wire connection, token ring or network connection, to name just a few examples. One example of a communications protocol used by one or more of these connections is TCP/IP which allows connection to a computer network, such as, for example, a local area network or a global computer network (e.g., the INTERNET).

The INTERNET comprises a vast number of computers and computer networks that are interconnected through communication links. The interconnected computers exchange information using various services, such as electronic mail, and the World Wide Web (“WWW”). The WWW service allows a server computer system (i.e., Web server or Web site) to send graphical Web pages of information to a remote client computer system. The remote client computer system can then display the Web pages. Each resource (e.g., computer or Web page) of the WWW is uniquely identifiable by a Uniform Resource Locator (“URL”). To view a specific Web page, a user's computer system specifies the URL for that Web page in a request (e.g., a HyperText Transfer Protocol (“HTTP”) request). The request can be, for example, directly input or performed through a hyperlink (or just “link”) which is text or graphics that when pointed to and selected creates the request. The request is forwarded to the Web server that supports that Web page. When that Web server receives the request, it sends that Web page to the user's computer system. When the user's computer system receives that Web page, it typically displays the Web page using a browser. A browser is a special-purpose application program that effects the requesting of Web pages and the displaying of Web pages. A user's computer system may use a browser such as, for example, Microsoft INTERNET EXPLORER or Netscape NAVIGATOR.

Web pages are typically defined using HyperText Markup Language (“HTML”). HTML provides a standard set of tags that define how a Web page is to be displayed. When a user indicates to the browser to display a Web page, the browser sends a request to the server computer system to transfer to the user's computer system an HTML document that defines the Web page. When the requested HTML document is received by the user's computer system, the browser displays the Web page as defined by the HTML document. The HTML document contains various tags that control the displaying of text, graphics, controls, and other features. The HTML document may additionally contain URLs of other Web pages available on that server computer system or other server computer systems.

FIG. 2 is a block diagram of one example of a system 200 for providing an estimated date of delivery for a made-to-order or out-of-stock item in an electronic transaction to a public electronic environment, e.g., a front end application on a global computer network, from a private electronic environment, e.g., a back end ERP application on a private computer network. System 200 comprises computing unit 202 housing a browser 204 (a front end application) coupled to a server 206 for a commerce site 208 via a global computer network 210. System 200 further comprises messaging middleware 212 for communication between server 206 and computing unit 214 housing back end ERP application 216. The ERP application includes a database 217 of inventory, manufacturing capacity, delivery information, entitled price contract information, and shipping information, among other information.

Messaging middleware 212 could be, for example, MSMQ from Microsoft in Redmond, Wash. However, the messaging middleware is preferably MQSERIES from IBM in Armonk, N.Y., since it runs on multiple different operating systems (e.g., MVS, VM, AIX, UNIX, Windows and more), whereas MSMQ runs only on the Microsoft Windows operating system. Further, the ERP application could be, for example, BAAN from the BAAN Company in The Netherlands, however, the ERP application is preferably SAP from SAP AG in Germany. Most preferably, the combination of MQSERIES and SAP is used.

The messaging middleware in this example is broken up into several components, including first messaging client 218, first messaging server 220, second messaging server 222 and second messaging client 224. First messaging client 218 is actually part of the programming for commerce site 208, and initiates communications from browser 204 to the messaging middleware. First messaging server 220 is a computing unit, and comprises a transmission queue 226 for outgoing communications with second messaging server 222 (also a computing unit), and a local queue 228 for incoming communications from second messaging server 222.

A firewall 230 separates the messaging servers. As one skilled in the art will know, a firewall physically comprises equipment and/or software for monitoring all incoming communications to messaging server 222 (and, in some scenarios, outgoing communications as well) for messages coming from predefined addresses (e.g., Internet Protocol (IP) addresses), and only allows messages from those addresses through. In addition, a firewall can monitor the type of incoming message (e.g., a request for a particular type of information). Second messaging server 222 comprises a holding queue 232 for holding incoming communications from messaging server 220, and a reply queue 234 for outgoing messages to messaging server 220. Second messaging client 224 comprises module 236 for issuing a command to ERP application 216 to calculate an estimated date of delivery. In one scenario, the second messaging client is a separate computing unit, however, it could instead be part of the same computing unit, for example, messaging server 222 or even computing unit 214.

In the present example, the messaging middleware (except, technically, for messaging client 218), firewall and ERP application all reside on a private computer network 238 (e.g., a local area network) while browser 204 and server 206 are part of global computer network 210, which is a public computer network. Server 206 can be considered to sit on both networks, connected to browser 204 through the global computer network, and to the other elements of private network 238 via messaging client 218. One example of a communications protocol on private network 238 is TCP/IP.

One example of providing an estimated date of delivery for a made-to-order or out-of-stock item to browser 204 from ERP application 216 will now be described. In this example, a user employing browser 204 initiates the communication by sending a request for an estimated date of delivery to commerce site 208 via global computer network 210. Assume that while browsing the items available at site 218, the user requests an estimated date of delivery for a particular made-to-order or out-of-stock item via browser 204. This could be done, for example, by selecting (using, e.g., a pointing device) a graphical button on the site near the item.

Typically, an ERP application will need information beyond simply the item of interest to the buyer, such as, for example, a location for shipment, a requested arrival date, and the date of the request (to check against the term of any entitlement contract that may apply). This could be done, for example, by the user providing this information, for instance, as part of the estimated date of delivery request. As another example, a small identifying program known as a “cookie” could be stored on computing unit 202 that would automatically provide such information that the user could change, if necessary, by entering different information into a request form, for example. As still another example, an identity for the user could be correlated to such information previously stored in the ERP application database.

Once the request is sent, the browser (and user) waits for the estimated date of delivery to be returned from ERP application 216 by commerce site 208. Upon receipt of the request (and any other necessary information, hereinafter collectively “the request” for upstream communications to the ERP application) by site 208 via server 206, messaging client 218 connects to messaging server 220 over standard connection 240. A connection is made, for example, via an application program interface (API), with messaging client 218 being preprogrammed with an address for messaging server 220. Once the connection is established, the messaging client then sends the request to the messaging server along with an identification of second messaging server 222 and, preferably, a unique token identifier to track the message path. The connection between messaging client 218 and messaging server 220 remains open, awaiting a reply. Also, preferably, the identification for second messaging server 222 is not the real address thereof, but something that can be correlated by first messaging server 220 into a real address. This masking of the real address is for security, since global computer network server 206 is exposed to a public computer network. Once the request and token identifier is received by messaging server 220, it is placed in transmission queue 226. The transmission queue is not intended to hold a request for any length of time, but simply acts as a temporary staging queue.

Once placed in transmission queue 226, the request and token identifier are immediately transmitted over an open channel 242 across firewall 230 to messaging server 222. Once received by messaging server 222, the request and the token identifier are placed in holding queue 232. Open channel 242 is actually a standard connection monitored and controlled by channel software residing on messaging server 222.

When the request and the token identifier are placed in holding queue 232, module 236 is, in some fashion, woken up. In one example, second messaging client 224 constantly monitors holding queue 232, and once something is placed therein, immediately retrieves the same. In any case, the request and token identifier are passed from messaging server 222 to messaging client 224 via standard connection 244. Depending on the messaging middleware used, module 236 may need to reformat the information being passed to match a format required by the particular ERP application being used. The function of module 236 is, however, to issue a command to ERP application 216 over standard connection 246 to calculate the estimated date of delivery. After issuing the command to the ERP application, messaging client 224, like the elements back to browser 204, waits for a reply to the request from the ERP application. In response to the command, ERP application 216 receives the request and the token identifier, accesses database 217 and calculates an estimated date of delivery.

It will be understood that the calculation of the estimated date of delivery is not part of the present invention. The invention simply requires the obtaining of the result, however, the way the result is produced is not relevant. In actual implementation, it is the ERP application that calculates the estimated date of delivery in any number of different ways, and that is how the present invention describes the obtaining of the estimated date of delivery.

After the ERP application calculates the estimated date of delivery, it returns the estimated date of delivery and the token identifier downstream to messaging client 224 over standard connection 248. Upon receipt of the estimated date of delivery, messaging client 224 immediately transfers the estimated date of delivery and token identifier to messaging server 222 over standard connection 250. Messaging server 222, upon receipt of the information, immediately places it in reply queue 234. Reply queue 234 points to messaging server 220 and, since there is an open channel 252 between the messaging servers, the estimated date of delivery is immediately transferred from reply queue 234 to messaging server 220. Open channel 252 is, like open channel 242, a standard connection monitored and controlled by software residing on messaging server 220, and once something is placed in estimated date of delivery queue 234, it immediately transfers the contents thereof to messaging server 220. Messaging server 220 then places the estimated date of delivery in local queue 228. Once messaging client 218 detects that something has been placed in local queue 228, it retrieves the estimated date of delivery and token identifier over standard connection 254, and confirms that the token identifier received matches the one that was originally sent. At this point, commerce site 208 returns the estimated date of delivery to browser 204 for display thereby over global computer network 210.

Although system 200 was described with two messaging server/client pairs, it will be understood that more or less such pairs could be used, and that a given pair need not be on separate computing units. For example, there could be another messaging server/client pair within computing unit 214. Additional messaging server/client pairs provide increased security, which could further be enhanced with additional firewalls. Further, it will be understood that the connection pairs between elements on private computer network 238 could each actually be a single, standard two-way connection.

Security for system 200 is also preferably enhanced through the use of encryption at various stages. For example, communications between computing unit 202 and server 206 are preferably encrypted. One example of such encryption is 128-bit SSL (secure socket layer) encryption, which is routinely used on global computer networks. In such a case, for example, requests from computing unit 202 to server 206 are encrypted by browser 204, and decrypted by commerce site 208. Further, as the request is received by messaging server 220 over connection 240, it is again encrypted. Examples of encryption algorithms that could be used include, for instance, DES and TRIPLE-DES available in various commercially available products from International Business Machines Corporation in Armonk, N.Y. Messaging server 222 then decrypts the request via channel 242 upon receipt. When the estimated date of delivery is coming back from ERP application 216, it is encrypted as it leaves messaging server 222 and decrypted as it leaves messaging server 220. In this case, since connection 254 is not a channel, the decryption is actually done by messaging server 220. It will be understood that the above encryption scheme is merely one example of numerous encryption schemes that could be used.

The above-described computing environment and/or computing units are only offered as examples. The present invention can be incorporated and used with many types of computing units, computers, processors, nodes, systems, work stations and/or environments without departing from the spirit of the present invention. Additionally, while some of the embodiments described herein are discussed in relation to servers and clients, such embodiments are only examples. Other types of computing environments can benefit from the present invention and, thus, are considered a part of the present invention.

Additionally, in various aspects of the present invention, the client need not be remote from the server. Various aspects of the invention are equally applicable to clients and servers running on the same physical machine, different physical machines or any combinations thereof.

The present invention can include at least one program storage device readable by a machine, tangibly embodying at least one program of instructions executable by the machine to perform the capabilities of the present invention. The program storage device can be provided separately, or as a part of a computer system.

The figures depicted herein are just exemplary. There may be many variations to these diagrams or the steps (or operations) described therein without departing from the spirit of the invention. For instance, the steps may be performed in a differing order, or steps may be added, deleted or modified. All of these variations are considered a part of the claimed invention.

While several aspects of the present invention have been described and depicted herein, alternative aspects may be effected by those skilled in the art to accomplish the same objectives. Accordingly, it is intended by the appended claims to cover all such alternative aspects as fall within the true spirit and scope of the invention.

1. A method of providing an estimated date of delivery in an electronic transaction, comprising:
electronically sending by a requestor a request for an estimated date of delivery for a made-to-order or out-of-stock item from a public electronic environment;
automatically routing the request to a private electronic environment;
obtaining the estimated date of delivery within the private electronic environment while the requestor waits; and
automatically returning the estimated date of delivery from the private electronic environment to the public electronic environment for providing to the requestor.

2. The method of claim 1, wherein the delivery is for a made-to-order item.

3. The method of claim 1, wherein the delivery is for an off-the-shelf item that is out of stock.

4. The method of claim 1, wherein the public electronic environment comprises a front end application, wherein the private electronic environment comprises a back end Enterprise Resource Planning (ERP) application, wherein the electronically sending comprises electronically sending by the requestor the request via the front end application, wherein the automatically routing comprises automatically routing the request to the ERP application, wherein the obtaining comprises obtaining the estimated date of delivery from the ERP application while the requestor waits, and wherein the automatically returning comprises automatically returning the estimated date of delivery from the ERP application to the front end application for providing to the requestor.

5. The method of claim 4, wherein the automatically routing and the automatically returning are accomplished at least in part by messaging middleware.

6. The method of claim 5, wherein the messaging middleware comprises MQSERIES, and wherein the ERP application comprises SAP.

7. The method of claim 5, wherein the messaging middleware comprises MQSERIES.

8. The method of claim 5, wherein the messaging middleware comprises MSMQ.

9. The method of claim 4, wherein the ERP application comprises SAP.

10. The method of claim 4, wherein the ERP application comprises BAAN.

11. The method of claim 4, wherein the public electronic environment comprises a global computer network, and wherein the front end application comprises a browser.

12. The method of claim 11, wherein the electronic transaction takes place at least partially over a global computer network, wherein the electronically sending comprises electronically sending the request to a global computer network site server, and wherein the automatically routing comprises:
forwarding the request from the global computer network site server to messaging middleware;
sending the request from the messaging middleware to the ERP application; and
causing by the messaging middleware a command to be issued to the ERP application.

13. The method of claim 12, wherein the automatically returning comprises:
sending the estimated date of delivery from the ERP application to the messaging middleware;
forwarding the estimated date of delivery from the messaging middleware to the global computer network site server; and
returning the estimated date of delivery from the global computer network site server to the browser.

14. The method of claim 13, further comprising encrypting and decrypting communications between the browser and the global computer network site server, and between the global computer network site server and the messaging middleware.

15. A system for providing an estimated date of delivery in an electronic transaction, comprising:
means for electronically sending by a requestor a request for an estimated date of delivery for a made-to-order or out-of-stock item from a public electronic environment;
means for automatically routing the request to a private electronic environment;
means for obtaining the estimated date of delivery within the private electronic environment while the requestor waits; and
means for automatically returning the estimated date of delivery from the private electronic environment to the public electronic environment for providing to the requestor.

16. The system of claim 15, wherein the delivery is for a made-to-order item.

17. The system of claim 15, wherein the delivery is for an off-the-shelf item that is out of stock.

18. The system of claim 1, wherein the public electronic environment comprises a front end application, wherein the private electronic environment comprises a back end Enterprise Resource Planning (ERP) application, wherein the means for electronically sending comprises means for electronically sending by the requestor the request via the front end application, wherein the means for automatically routing comprises means for automatically routing the request to the ERP application, wherein the means for obtaining comprises means for obtaining the estimated date of delivery from the ERP application while the requestor waits, and wherein the means for automatically returning comprises means for automatically returning the estimated date of delivery from the ERP application to the front end application for providing to the requestor.

19. The system of claim 18, wherein the means for automatically routing and the means for automatically returning comprise messaging middleware.

20. The system of claim 19, wherein the messaging middleware comprises MQSERIES, and wherein the ERP application comprises SAP.

21. The system of claim 19, wherein the messaging middleware comprises MQSERIES.

22. The system of claim 19, wherein the messaging middleware comprises MSMQ.

23. The system of claim 18, wherein the ERP application comprises SAP.

24. The system of claim 18, wherein the ERP application comprises BAAN.

25. The system of claim 18, wherein the public electronic environment comprises a global computer network, and wherein the front end application comprises a browser.

26. The system of claim 25, wherein the electronic transaction takes place at least partially over a global computer network, wherein the means for electronically sending comprises means for electronically sending the request to a global computer network site server, and wherein the means for automatically routing comprises:
means for forwarding the request from the global computer network site server to messaging middleware;
means for sending the request from the messaging middleware to the ERP application; and
means for causing by the messaging middleware a command to be issued to the ERP application.

27. The system of claim 26, wherein the means for automatically returning comprises:
means for sending the estimated date of delivery from the ERP application to the messaging middleware;
means for forwarding the estimated date of delivery from the messaging middleware to the global computer network site server; and
means for returning the estimated date of delivery from the global computer network site server to the browser.

28. The system of claim 27, further comprising:
means for encrypting and decrypting communications between the browser and the global computer network site server; and
means for encrypting and decrypting communications between the global computer network site server and the messaging middleware.

29. At least one program storage device readable by a machine, tangibly embodying at least one program of instructions executable by the machine to perform a method of providing an estimated date of delivery in an electronic transaction, comprising:
electronically sending by a requestor a request for an estimated date of delivery for a made-to-order or out-of-stock item from a public electronic environment;
automatically routing the request to a private electronic environment;
obtaining the estimated date of delivery within the private electronic environment while the requestor waits; and
automatically returning the estimated date of delivery from the private electronic environment to the public electronic environment for providing to the requestor.

30. The at least one program storage device of claim 29, wherein the delivery is for a made-to-order item.

31. The at least one program storage device of claim 29, wherein the delivery is for an off-the-shelf item that is out of stock.

32. The at least one program storage device of claim 29, wherein the public electronic environment comprises a front end application, wherein the private electronic environment comprises a back end Enterprise Resource Planning (ERP) application, wherein the electronically sending comprises electronically sending by the requestor the request via the front end application, wherein the automatically routing comprises automatically routing the request to the ERP application, wherein the obtaining comprises obtaining the estimated date of delivery from the ERP application while the requestor waits, and wherein the automatically returning comprises automatically returning the estimated date of delivery from the ERP application to the front end application for providing to the requestor.

33. The at least one program storage device of claim 32, wherein the automatically routing and the automatically returning are accomplished at least in part by messaging middleware.

34. The at least one program storage device of claim 33, wherein the messaging middleware comprises MQSERIES, and wherein the ERP application comprises SAP.

35. The at least one program storage device of claim 33, wherein the messaging middleware comprises MQSERIES.

36. The at least one program storage device of claim 33, wherein the messaging middleware comprises MSMQ.

37. The at least one program storage device of claim 32, wherein the ERP application comprises SAP.

38. The at least one program storage device of claim 32, wherein the ERP application comprises BAAN.

39. The at least one program storage device of claim 32, wherein the front end application comprises a browser.

40. The at least one program storage device of claim 39, wherein the electronic transaction takes place at least partially over a global computer network, wherein the electronically sending comprises electronically sending the request to a global computer network site server, and wherein the automatically routing comprises:
forwarding the request from the global computer network site server to messaging middleware;
sending the request from the messaging middleware to the ERP application; and
causing by the messaging middleware a command to be issued to the ERP application.

41. The at least one program storage device of claim 40, wherein the automatically returning comprises:
sending the estimated date of delivery from the ERP application to the messaging middleware;
forwarding the estimated date of delivery from the messaging middleware to the global computer network site server; and
returning the estimated date of delivery from the global computer network site server to the browser.

42. The at least one program storage device of claim 41, further comprising encrypting and decrypting communications between the browser and the global computer network site server, and between the global computer network site server and the messaging middleware.
